(19) United States
(12) Patent Application Publication
(10) Pub. No.: US 2014/0325805 A1
(43) Pub. Date: Nov. 6, 2014

(54) SNAP-HOOK LATCH

(71) Applicant: Armando Troiano, Ontario (CA)

(72) Inventor: Armando Troiano, Ontario (CA)

(21) Appl. No.: 13/888,199

(22) Filed: May 6, 2013

(51) Int. Cl. F16B 45/04; F16B 21/07; E05C 19/00; B65F 1/14

(52) U.S. Cl. CPC F16B 45/04; B65F 1/1615; F16B 21/073; E05C 19/00
USPC 24/600.5

(57) ABSTRACT

Described herein is a latch useful for safety or security purposes, comprising: a cable having a first end coupled to a finger actuated, spring-loaded, sliding bolt, snap-hook and a second end coupled to a first mounting plate; a first ring coupled to a second mounting plate;

the first and second mounting plates each defining at least one aperture for receiving a fastener for attaching the first and second mounting plates to a main body of an enclosure and an openable barrier of the enclosure, respectively; the latch being in a closed state with the snap-hook linked to the first ring and an open state with the snap-hook disengaged from the first ring.

### BACKGROUND OF THE INVENTION

1. Field of the Invention

The present invention relates to a latch, and more particularly a quick-release latch.

2. Description of the Related Art

Enclosures such as rooms, containers, fenced land, and the like define an interior cavity with opening(s) communicative with the exterior of the enclosure. The opening may be sealed by barriers or covers such as doors, windows, gates, lids and the like. In many cases, the barriers or covers may be fastened to the enclosure using a latch. A typical latch comprises an engagement of at least a pair of mating mechanical parts with one part connected to the enclosure and the other part connected to the barrier or cover. A quick-release latch allows the mating mechanical parts to be disengaged without a key and by simple manual manipulation.

For example, a common latch is a sliding chain door latch comprising a plate with a track mounted on an interior surface of a door and a chain with a pin having a flanged end that slidably engages the track. The chain is mounted to the door frame. The pin cannot be disengaged from the track except at a through hole at an end of the track positioned furthest from the door perimeter. U.S. Pat. Nos. 3,101,603 (issued 27 Aug. 1963), 3,161,035 (issued 15 Dec. 1964), 3,705,504 (issued 1 Dec. 1972), 4,600,226 (issued 15 Jul. 1986), and 5,076,624 (issued 31 Dec. 1991) disclose examples of such sliding chain door latch devices. An advantage of the sliding chain door latch is that a person inside an enclosure can allow a chain-restricted opening of the door for purposes of communicating with individuals outside or exchanging small objects through the chain-restricted opening while still preventing the individuals outside from gaining access to the enclosure. A disadvantage of this latch is that the pin may be disengaged from the track by an individual outside the enclosure using simple tools or even by hand if the chain-restricted opening is sufficiently wide.

Another example of a latch may be found on a container for collecting waste or recyclables. The latch fastens a cover to the container. Containers for collecting waste or recyclables intended for curbside pick-up are generally kept outdoors to minimize smells from the receptacles from permeating an indoors environment. However, placing the receptacles outdoors can attract scavenging animals such as raccoons, skunks, rats, squirrels, and the like. A latch that fastens the cover to the container prevents the scavenging animal from rummaging through the container and spilling the contents on the ground. Trash strewn on the ground by scavenging animals creates potential for health hazards and environmental hazards. U.S. Pat. Nos. 3,980,202 (issued 14 Sep. 1976), 4,520,945 (issued 4 Jun. 1985), 5,078,295 (issued 7 Jan. 1992), 6,041,960 (issued 28 Mar. 2000), and 7,086,557 (issued 8 Aug. 2006) all provide a latch for fastening a cover to a container. However, the latches described in these disclosures suffer from deficiencies of being cumbersome to disengage or engage, and/or being awkwardly positioned when disengaged and/or lacking efficacy in preventing intrusions by scavenging animals.

Accordingly, there is a continuing need for an alternative latch for fastening a barrier or cover to its enclosure.

### SUMMARY OF THE INVENTION

In an aspect there is provided a quick-release latch, comprising: a metal cable having a first end coupled to a finger actuated, spring-loaded, sliding bolt, snap-hook and a second end coupled to a first mounting plate;

a first ring coupled to a second mounting plate; the first and second mounting plates each defining at least one aperture for receiving a fastener for attaching the first and second mounting plates to a main body of an enclosure and an openable barrier of the enclosure, respectively;

the latch being in a closed state with the snap-hook linked to the first ring and an open state with the snap-hook disengaged from the first ring.

In another aspect there is provided a snap-hook comprising:

a shaft defining a hollow tubular cavity having a longitudinal axis, an open end communicative with the hollow tubular cavity, a closed end, a first longitudinal slot, a second longitudinal slot rotationally displaced from the first longitudinal slot, a lateral slot communicative with both the first longitudinal slot and the second longitudinal slot;

the first and second longitudinal slots and the lateral slot communicative with the hollow tubular cavity;

a hook comprising a connected end and a free end, the connected end formed on and extending from the open end of the shaft, the free end aligned with the axis of the hollow tubular cavity;

a bolt moveable between an open position and a closed position, the bolt comprising an inner end housed within the shaft and an outer end that abuts the free end of the hook when the bolt is in a closed position;

a spring disposed between the inner end of the bolt and the closed end of the shaft biasing the bolt to a closed position; and

a finger actuator extending radially from the bolt and through one of the first and second longitudinal slots and the lateral slot.

### BRIEF DESCRIPTION OF THE DRAWINGS

FIG. 1 shows a perspective view of a quick-release latch;

FIG. 2 shows a perspective view of the quick-release latch shown in FIG. 1 installed on a waste container;

FIG. 3 shows an exploded view of a snap-hook that may be used with the quick-release latch shown in FIG. 1; and

FIG. 4 (4A to 4F) shows various configurations of slots on the shaft of the snap-hook shown in FIG. 3.

### DETAILED DESCRIPTION OF THE PREFERRED EMBODIMENT

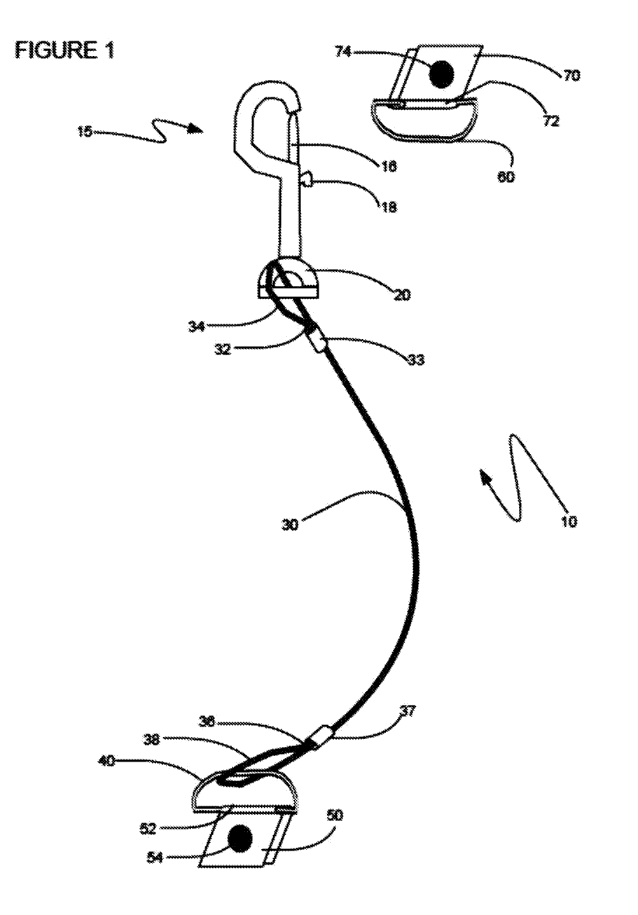

Referring to the drawings, FIG. 1 shows a perspective view of a quick-release latch 10. The quick-release latch 10 includes a spring-loaded, sliding bolt, snap-hook 15. The snap-hook 15 is opened and closed by movement of the sliding bolt 16. A finger actuator button or tab 18 extending radially from the sliding bolt 16 allows for manual manipulation to move the sliding bolt to an open position. In the absence of manual manipulation the sliding bolt is biased to a closed position. The snap-hook 15 includes a closed loop swivel base 20.

A metal cable 30 comprises a first end 32 and a second end 36. The first end 32 is coupled to the closed loop swivel base 20. The first end 32 is passed through closed loop swivel base 20 and connected to a portion of metal cable 30 proximal to the first end 32 using metal clip 33. Connection of first end 32 to a proximal portion of metal cable 30 forms a closed loop 34 that intersects or links with closed loop swivel base 20. Closed loop 34 and closed loop swivel base 20 are slidably linked, such that both the slidable linkage and the swivel freedom of the base 20 cooperate to reduce torsional strain on the metal cable 30 and/or other components of the latch including the snap-hook and the D-rings.

The second end 36 of metal cable 30 is coupled to a first D-ring 40. The second end 36 is passed through first D-ring 40 and connected to a portion of metal cable 30 proximal to the second end 36 using metal clip 37. Connection of second end 36 to a proximal portion of metal cable 30 forms a closed loop 38 that intersects or links with first D-ring 40. Closed loop 38 and D-ring 40 are slidably linked, such that both the slidable linkage and the hinged freedom of the D-ring 40 cooperate to reduce torsional strain on the metal cable 30 and/or other components of the latch including the snap-hook and the D-rings.

First D-ring 40 is hingedly coupled to a first mounting plate 50. First mounting plate 50 comprises a substantially cylindrical portion 52 to hingedly capture a portion of first D-ring 40. First mounting plate 50 defines an aperture 54 for use with permanent fasteners such as rivets or semi-permanent fasteners such as nuts/bolts for connecting first mounting plate 50 to the body of an enclosure.

Second D-ring 60 is hingedly coupled to a second mounting plate 70. Second mounting plate 70 comprises a substantially cylindrical portion 72 to hingedly capture a portion of second D-ring 60. Second mounting plate 70 defines an aperture 74 for use with permanent fasteners such as rivets or semi-permanent fasteners such as nuts/bolts for connecting mounting plate 70 to a cover or barrier of an enclosure. Linking snap-hook 15 with second D-ring 60 fastens a cover or barrier of an enclosure to the body of the enclosure, and disengaging snap-hook 15 from second D-ring 60 releases the cover or barrier to be opened.

First and second mounting plates 50 and 70 are similarly constructed. Each is made from a metal strap folded along a substantially cylindrical joint 52 and 72, respectively, to produce two parallel plates with abutting planar faces. Apertures 54 and 74, respectively, are coincident in the two parallel plates. The substantially cylindrical joints 52 and 72 hingedly capture the D-rings 40 and 60, respectively.

In use, quick-release latch 10 may have multiple applications for safety and/or security purposes.

For example, quick-release latch 10 may be used to replace existing sliding chain door latches. First mounting plate 50 can be mounted to a door frame, while second mounting plate 70 can be mounted on a door. Linking snap-hook 15 with second D-ring 60 restricts opening of the door, and disengaging snap-hook 15 from second D-ring 60 releases the door to be opened. Quick-release latch 10 provides a cable-restricted door opening advantage equivalent to that provided by the sliding chain door latch. Quick-release latch 10 improves upon the sliding chain door latch in that quick-release latch 10 is more difficult to disengage by an individual standing outside the door, while both quick-release latch 10 and the sliding chain door latch provide a similar quick-release function for an individual standing on the inside of the door.

Quick-release latch 10 may be packaged in a kit comprising the quick-release latch, fasteners for attaching the mounting plates to a targeted surface, and instructions for installing the quick-release latch on a door and its door frame.

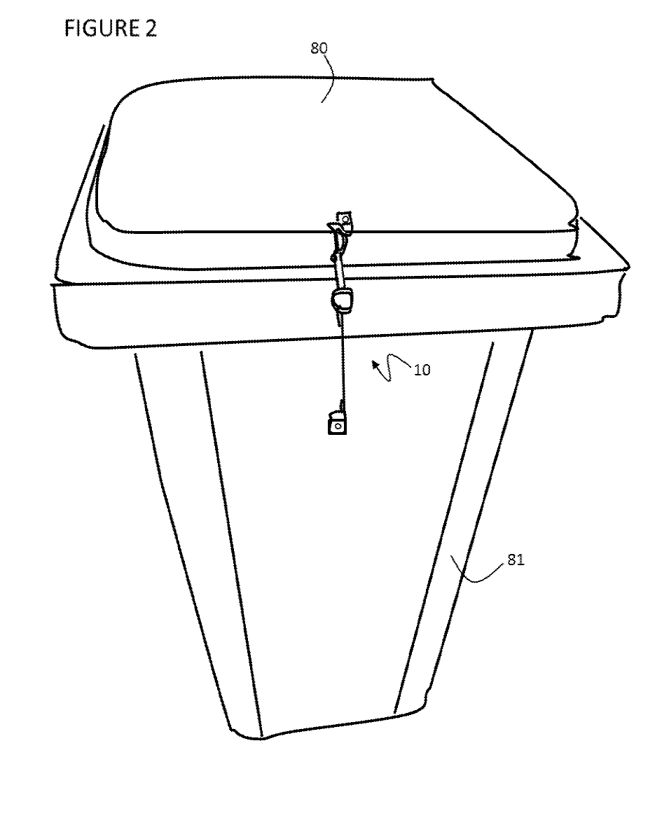

In another example, quick-release latch 10 may be used to control opening of the cover of a waste container. Installing a latch on a waste container kept outdoors prevents scavenging animals from accessing the contents of the waste container and making a mess and associated health and environmental hazards. Examples of waste containers include garbage containers, recycling containers and composting containers. As shown in FIG. 2, the quick-release latch 10 may be used to fasten the cover 80 of a waste container to the body or can 81 of the waste container. First mounting plate 50 can be mounted to the body 81, while second mounting plate 70 can be mounted on the cover 80. Linking snap-hook 15 with second D-ring 60 restricts opening of the cover, and disengaging snap-hook 15 from second D-ring 60 releases the cover to be opened. First and second mounting plates 50 and 70 are positioned so that when snap-hook 15 is linked to second D-ring 60 the metal cable 30 is taut, thus preventing a scavenging animal from accessing the interior of the container. During curbside pick-up of the contents of the container, snap-hook 15 is disengaged from the second D-ring 60, and allowed to hang by force of gravity. Due to hinged coupling of the first D-ring 40 with the first mounting plate 50, the metal cable 30 and snap-hook 15 hang flush with the body of the container when disengaged. Thus, the first D-ring 40 provides a hinged coupling of metal cable 30 to the first mounting plate 50. A lack of a hinged coupling of the metal cable 30 to the first mounting plate 50 results in the metal cable 30 hanging in an arcuate line extending away from the body of the container when disengaged providing potential for the metal cable 30 and/or the snap-hook 15 to become unintentionally touched by or entangled with an individual walking by.

Quick-release latch 10 may be packaged in a kit comprising the quick-release latch, fasteners for attaching the mounting plates to a targeted surface, and instructions for installing the quick-release latch on a cover and body of a waste container.

For uses, where the containers are kept outdoors, a choice of metal comprising an anti-rust coating such as galvanized metal for one or more of the metal cable, the snap-hook, the mounting plates, and the D-rings is beneficial to prevent rusting of the latch. For outdoor uses, the entire quick-release latch may be made of components comprising an anti-rust coating such as galvanized metal.

For waste containers comprising a cover hingedly coupled to the body of the waste container, a single quick-release latch is typically installed on surfaces of the cover and body of the container that oppose the hinged coupling of the cover and the body. For waste containers having a freely removable cover, typically two quick-release latches are installed on the container, one each on opposing sides of the container.

Still further examples of uses include latching of shipping containers, fence doors, cages and windows.

An illustrative version of the quick-release latch has been described above. For further illustration, several variations of the quick-release latch are now described.

The length of metal cable 30 will depend upon the specific application of the quick-release latch. Typically, the length will range from 10 cm to 90 cm.

The thickness or diameter of the metal cable 30 will also depend upon the specific application of the quick-release latch. Typically, the thickness will range from 0.2 cm to 5 cm.

The cable may be a rope-type cable or a chain-type cable. The stress tolerance of each of the components of the latch may be adjusted depending on the expected stress forces of a particular application. Each of the components may be manufactured with a desired stress tolerance. For example, the breaking strength of the metal cable will typically be greater than 200 pounds, 250 pounds, 300 pounds, 350 pounds, 400 pounds, 450 pounds or greater than any number therebetween.

Coupling of the first end 32 of the metal cable 30 to the snap-hook 15 may be achieved by any convenient method including soldering, clamping, clipping, gluing and the like. Similarly, coupling of the second end of the metal cable to the first mounting plate 50 or the first D-ring 40 may be achieved by any convenient method.

A hinged or pivot coupling of the metal cable 30 to the first mounting plate 50 provides a benefit of the metal cable 30 and the snap-hook 15 hanging flush with the surface to which the first mounting plate 50 is attached. In applications where this benefit is not desired the metal cable 30 may be coupled to the first mounting plate 50 without a hinge or pivot. The first D-ring 40 provides an example of a cost-effective and durable mechanism of a hinged coupling of the metal cable 30 to the first mounting plate 50. Depending on the application, other mechanisms may be contemplated. For example, a column rotatably coupled to the first mounting plate 50, the column having an aperture for receiving the second end 36 of the metal cable 30.

D-rings may be replaced by any closed loop structures.

The mounting plates can be any structure that can be secured to an enclosure body or its cover/barrier and can be coupled to a metal cable or a closed loop structure such as a D-ring. Typically, the mounting plate will be a planar structure of circular or polygonal shape.

The mounting plates may be secured to an enclosure body or its cover/barrier using any convenient permanent or semi-permanent fastener including, for example, glue, nuts/bolts, screws, nails or rivets. The mounting plates may define an aperture for receiving a fastener.

The quick-release latch will have properties of a quick-release and/or a need for manual dexterity for executing a quick-release. Snap-hooks generally encompass both properties providing a quick-release, but requiring some manual dexterity to achieve the quick-release. Most snap-hooks comprise a moveable clasp biased to a closed position. The manual dexterity required to disengage or open the moveable clasp of a snap-hook is greater than the manual dexterity capability of most animals.

Depending on the application various types of snap-hooks may be incorporated into the quick-release latch. Snap-hooks are known for a variety of purposes. Typically a snap-hook includes a hook and a lever that opens/closes the hook. Bolt snap-hooks provide a finger, typically thumb, operated spring-loaded bolt plunger, with an up and down motion. To open the bolt snap-hook, pressure is applied to a thumb tab to push down the bolt plunger. Also, the thumb tab must be depressed to link the snap-hook to an object. Bull snap-hooks employ a swivel tab that pulls outward to open the snap-hook. However, this requires the use of two hands; one to hold the snap-hook and another to pull the tab outward. Marine snap-hooks incorporate a spring loaded tab, folding inward to open, to hook an object. However, disengaging/opening this snap-hook from an object with one hand requires great dexterity, and can force the finger(s), used to push/fold back the tab, between the tab and the body of the snap-hook. Still further types of snap-hooks are known.

Snap-hook 15 is a finger actuated, spring-loaded, sliding bolt, snap-hook as described, for example, in U.S. Pat. Nos. 275,537 (issued 10 Apr. 1883), 553,137 (issued 14 Jan. 1896), 701,586 (issued 3 Jun. 1902), 759,806 (issued 10 May 1904), 898,789 (issued 15 Sep. 1908), 1,521,387 (issued 30 Dec. 1924), 1,598,684 (issued 7 Sep. 1926), 3,973,301 (issued 10 Aug. 1976), 4,372,016 (issued 8 Feb. 1983), 4,443,917 (issued 24 Apr. 1984), 4,689,860 (issued 1 Sep. 1987), 6,948,218 (issued 27 Sep. 2005), 7,472,461 (issued 6 Jan. 2009), and 7,526,843 (issued 5 May 2009). This type of snap-hook provides a benefit of quick-release by an individual having easy access to manipulate the finger actuator 18, while also providing a benefit of preventing opening of the sliding bolt by animals due to limited or lack of ability of animals to manipulate the finger actuator. Similar benefits are provided in the example of using the quick-release latch to replace a sliding chain door latch, where an individual on the inside of a door can benefit from a quick-release characteristic, while an individual on the outside of a door will have more difficulty manipulating the finger actuator than disengaging the sliding chain door latch. Depending on the application, if benefits of the finger actuator are not desired then other snap-hook types may be used.

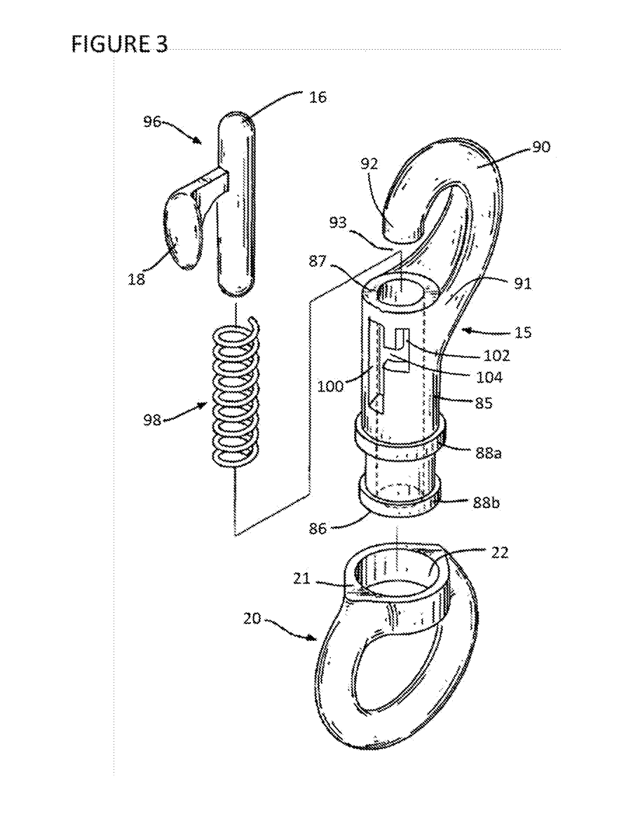

FIG. 3 shows a perspective exploded view of a modification of snap-hook 15. Snap-hook 15 comprises a shaft portion 85 and a hook portion 90. Shaft 85 of generally columnar structure comprises a hollow interior cavity defining a longitudinal axis, a closed end 86 and an open end 87 communicative with the hollow interior cavity. First longitudinal slot 100 and second longitudinal slot 102 are formed on the surface of shaft 85, and both are communicative with the hollow interior cavity of the shaft 85. The second longitudinal slot 102 is rotationally displaced from the first longitudinal slot. Lateral slot 104 is communicative between the first and second longitudinal slots 100 and 102, while also communicating with the hollow interior cavity. Hook 90 of generally arcuate shape comprises an attached end 91 that is integrally formed on and extends from the open end 87 of the shaft 85, and a free end 92 that is aligned with the axis of the hollow interior cavity of the shaft. The hook 90 defines an opening 93 in between the free end 92 and the open 86 of the shaft. Opening 93 is regulated by moveable clasp 96. Moveable clasp 96, moveable from a closed position to an open position, comprises the bolt 16 and the finger actuator 18 extending radially from the bolt 16. Bolt 16 is generally cylindrical with an inner end that remains housed within the shaft throughout movement of the bolt, and an outer end that abuts the free end 92 of the hook when the clasp is in a closed position. Bolt 16 is sized to fit and slide within the hollow interior cavity and a neck of the finger actuator 18 that connects to the bolt 16 is sized to fit and slide within the first and second longitudinal slots 100 and 102, and the lateral slot 104. Bolt 16 is moveable from a closed position to an open position. Bolt 16 is biased to a closed position by spring 98 positioned in the hollow interior cavity in between the inner end of the bolt and the closed end 86 of the shaft. Shaft 85 is rotatably connected to closed loop swivel base 20. Swivel base 20 comprises a closed loop attached to a mounting sleeve 21. Mounting sleeve 21 defines bore 22 therethrough such that mounting sleeve 21 has two open ends. Bore 22 is sized to receive the closed end 86 of shaft 85 with collars 88a and 88b positioned on either end of mounting sleeve 21 to rotationally hold the shaft 85 within mounting sleeve 21.

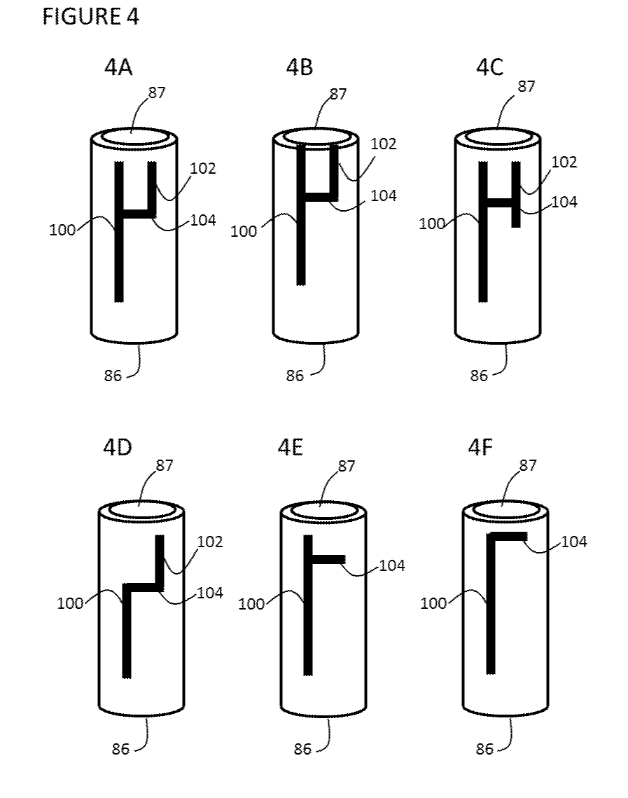

Existing spring loaded, sliding bolt, snap-hooks comprise a single longitudinal slot through which a finger actuator extends radially from the sliding bolt. The modified snap-hook shown in FIG. 3 comprises a first longitudinal slot 100, second longitudinal slot 102 and a lateral slot 104 connecting the first and second longitudinal slots. FIGS. 4A to 4F show several illustrative configurations of a first longitudinal slot 100 with either a lateral slot 104 or both a lateral slot 104 and a second longitudinal slot 102. The lateral slot and/or the second longitudinal slot are typically located proximal to the open end of the shaft (ie., closer to the open end 87 than the closed end 86). The lateral slot and/or the second longitudinal slot are typically shorter than the first longitudinal slot. For example, the length of the first longitudinal slot may be more than double the length of the second longitudinal slot or the lateral slot. In other examples, the length of the first longitudinal slot may be more than 1.5 times, 1.6 times, 1.7 times, 1.8 times, or 1.9 times the length of the second longitudinal slot or the lateral slot. When a second longitudinal slot is included, it will typically be sized such that any partial opening of the bolt by directing the finger actuator along the second longitudinal slot will be insufficient to disengage the hook from an object. When the bolt is in a closed position, placing the finger actuator in either the lateral slot or the second longitudinal slot increases manual dexterity to slide the bolt to an open position compared to existing slot configurations. The addition of a lateral slot or both a lateral and a second longitudinal slot allows for a greater manual dexterity to move the bolt to an open position by requiring the finger actuator to be directed through the second longitudinal slot and/or the lateral slot. The greater manual dexterity reduces the probability of unintentional disengagement of the snap-hook, while preserving the quick-release characteristic of the snap-hook.

Swivel base 20 of the snap-hook 15 is useful for manipulating the snap-hook to access the finger actuator 18, as well as to release any torsional stress on the metal cable 30 or other components of the quick-release latch. Swivel base 20 may be omitted where these benefits are not desired.

The quick-release latch may be made of conventional materials used for producing latches including, for example ,metals, plastics and other synthetic or semi-synthetic moldable materials such as kevlar or nylon. Combinations of materials may be used such as a metal cable and snap-hook in combination with plastic mounting plates. The quick-release latch will typically be constructed with one or more metal components. Metal components provide a benefit of resistance to cutting or chewing. Furthermore, one or more components may be made of metal coated with a rust-prevention or corrosion-prevention compound such as nickel coated metal, chromium coated metal, aluminum coated metal, zinc coated metal, magnesium coated metal or combinations thereof. Where metal components are used one or more of the components may be made of galvanized metal. Typically, galvanized coatings comprise zinc, aluminum, magnesium or their alloys. Rust prevention coatings such as black oxide or phosphating may also be useful.

Still further variants, equivalents and combinations thereof will be recognized by a person of skill in the art.

What is claimed is:

1. A quick-release latch, comprising:
a metal cable having a first end coupled to a finger actuated, spring-loaded, sliding bolt, snap-hook and a second end coupled to a first mounting plate;
a first ring coupled to a second mounting plate;
the first and second mounting plates each defining at least one aperture for receiving a fastener for attaching the first and second mounting plates to a main body of an enclosure and an openable barrier of the enclosure, respectively;
the latch being in a closed state with the snap-hook linked to the first ring and an open state with the snap-hook disengaged from the first ring.

2. The quick-release latch of claim 1, wherein the first end of the metal cable is pivotally coupled to the snap-hook.

3. The quick-release latch of claim 2, wherein the snap-hook further comprises a closed loop swivel base and the first end of the metal cable is coupled to the swivel base.

4. The quick-release latch of claim 3, wherein the first end of the metal cable is a closed loop slidably linked with the closed loop swivel base.

5. The quick-release latch of claim 1, wherein the second end of the metal cable is pivotally coupled to the first mounting plate.

6. The quick-release latch of claim 5, further comprising a second ring hingedly couple to the first mounting plate and the first end of the metal cable coupled to the second ring.

7. The quick-release latch of claim 6, wherein the second end of the metal cable is a closed loop slidably linked with the second ring.

8. The quick-release latch of claim 1, wherein the first ring is pivotally coupled to the second mounting plate.

9. The quick-release latch of claim 1, wherein a shaft of the snap-hook comprises first and second longitudinal slots of differing lengths, both communicative with an interior cavity of the shaft, and a lateral slot communicative with both the first and second longitudinal slots.

10. The quick-release latch of claim 9, wherein the length of the first longitudinal slot is more than double the length of the second longitudinal slot.

11. The quick-release latch of claim 1, wherein one or more components of the latch are made of galvanized metal.

12. The quick-release latch of claim 1, wherein all the components of the latch are made of galvanized metal.

13. The quick-release latch of claim 1, wherein the latch is installed on a waste container.

14. The quick-release latch of claim 1, wherein the latch is installed on a door.

15. A kit comprising the quick-release latch of claim 1, fasteners for mounting the latch on a waste container, and instructions for installing the latch on a waste container.

16. A kit comprising the quick-release latch of claim 1, fasteners for mounting the latch on a door, and instructions for installing the latch on a door.

17. A snap-hook comprising:
a shaft defining a hollow tubular cavity having a longitudinal axis, an open end communicative with the hollow tubular cavity, a closed end, a first longitudinal slot, a second longitudinal slot rotationally displaced from the first longitudinal slot, a lateral slot communicative with both the first longitudinal slot and the second longitudinal slot;
the first and second longitudinal slots and the lateral slot communicative with the hollow tubular cavity;
a hook comprising a connected end and a free end, the connected end formed on and extending from the open end of the shaft, the free end aligned with the axis of the hollow tubular cavity;
a bolt moveable between an open position and a closed position, the bolt comprising an inner end housed within the shaft and an outer end that abuts the free end of the hook when the bolt is in a closed position;
a spring disposed between the inner end of the bolt and the closed end of the shaft biasing the bolt to a closed position; and
a finger actuator extending radially from the bolt and through one of the first and second longitudinal slots and the lateral slot.
